(19) United States
(12) Patent Application Publication
(10) Pub. No.: US 2022/0335649 A1
(43) Pub. Date: Oct. 20, 2022

(54) CAMERA POSE DETERMINATIONS WITH DEPTH

(71) Applicant: HEWLETT-PACKARD DEVELOPMENT COMPANY, L.P., Spring, TX (US)

(72) Inventors: Vijaykumar NAYAK, San Diego, CA (US); Yun David TANG, San Diego, CA (US); Nathan Reede Mazhar GODWIN, San Diego, CA (US); Shaymus Jamil ALWAN, San Diego, CA (US); Andy Yi-Chih LIAO, San Diego, CA (US)

(21) Appl. No.: 17/641,917

(22) PCT Filed: Oct. 30, 2019
(86) PCT No.: PCT/US2019/058964

§ 371 Date: Mar. 10, 2022

(51) Int. Cl. G06T 7/73

(52) U.S. Cl. CPC G06T 7/74; G06T 2207/30244; G06T 2207/30204; G06T 2207/10028

(57) ABSTRACT

An example system includes a camera aimable at a planar platform, a depth sensor aimable at the planar platform, and a controller to control the camera to obtain a captured image of the planar platform. The controller is further to control the depth sensor to capture depth data of the planar platform. The controller is further to determine a pose of the camera using the depth data and features extracted from the captured image.

### BACKGROUND

Cameras may be used in three-dimensional (3D) scanning systems, virtual or augmented reality (VR or AR) systems, robotics systems, assisted or autonomous driving systems, and the like. The pose of a camera, that is, its actual position and orientation within a frame of reference, may be used to reduce error in processing information from images captured by the camera. For example, in an AR system, an accurate camera pose may allow for increased accuracy in positioning an overlay graphic. Similarly, accuracy in object scanning or tracking may be increased with a more accurate camera pose.

### BRIEF DESCRIPTION OF THE DRAWINGS

FIG. 1 is a schematic diagram of an example system to determine a pose of a camera based on image features and depth data.

FIG. 2 is a schematic diagram of an example pose determination of a camera based on image features and depth data.

FIG. 3 is a flowchart of an example method to determine camera pose using image features and depth data.

FIG. 4 is a flowchart of another example method to determine camera pose using image features and depth data.

FIG. 5 is a diagram showing a plane skewed with respect to a camera for which depth and feature data is used to determine pose.

FIG. 6 is a schematic diagram of an example system to determine poses of a cameras based on image features and depth data.

FIGS. 7A to 7C are schematic diagrams of example layouts for unique markers.

FIG. 8 is a plan view of an example platform including arrangement of decodable markers to determine a pose of a camera based on image features and depth data.

### DETAILED DESCRIPTION

Camera pose, which is also known as camera localization, may be described by six degrees of freedom, such as the camera's position (e.g., Tx, Ty, Tz) and the camera's orientation (e.g., Rx, Ry, Rz) relative to an origin or datum in a 3D world coordinate system.

Image analysis may be used determine camera pose. In techniques such as Perspective N-Point, the precision of feature extraction may limit the accuracy of the determined pose. In some cases, sub-pixel precision is needed to produce an accurate estimation of camera pose. Further, the accuracy of many image-based techniques may rely on a large number of markers or other determined features. This may reduce robustness to changes in acquisition environment, such as lighting changes and occlusions, as fewer features detected tends to reduce the accuracy of pose determination.

As discussed herein, depth data may be used in conjunction with features extracted from captured images to increase the accuracy and robustness of camera localization. The depth data and image features may be specific to a planar object, such as a flat platform, which may be used to support a target object. A plane equation may be used to enforce a geometric constraint on the depth data, which may reduce error in the depth data and therefore increase accuracy of camera pose determination. Further, the use of depth data may reduce the number of markers or other features needed.

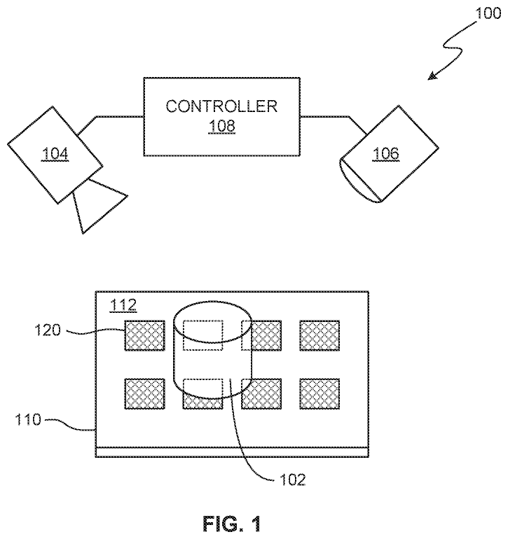

FIG. 1 shows an example system 100. The system 100 captures images and depth information that may be used to generate 3D data of a target object 102. The system 100 may be a 3D scanner, smartphone, computing device, or similar device. The target object 102 may be used in certain example implementations, such as 3D scanning. In other examples, the target object is not used. For example, in VR/AR scene reconstruction, a target object may be omitted, with scene reconstruction being facilitated by a planar object, such as a planar platform, discussed below.

The system 100 includes a camera 104, a depth sensor 106, and a controller 108 connected to the camera 104 and depth sensor 106. The camera 104 and depth sensor 106 may be aimed towards a planar object, such as a planar platform 110. The target object 102 may be placed on or above the platform 110, so that the target object 102 is partially or fully located within the fields of view of the camera 104 and depth sensor 106.

The system 100 may be assembled and disassembled. When disassembled, its components may be stored and/or transported together. When assembled, its components may be affixed relative to one another and generally stationary. The platform 110 may form part of the system 100.

The camera 104 may capture visible light, infrared (IR) light, or both to obtain images of the target object 102 and planar platform 110.

The camera 104 may include the depth sensor 106. For example, the camera may be an RGB-D camera with an integrated depth sensor. Two-dimensional images and depth information may be related to each other by a predetermined relationship, which may be established during a pre-calibration at time of manufacture or factory testing of the camera 104 or system 100.

The camera 104 may have intrinsic properties, such as focal length and principal point location, and an extrinsic transformation that describes a position and orientation of the camera 104 in the world coordinate system. The depth sensor 106, when included with the camera 104, may be pre-calibrated with intrinsic properties of a camera, such focal length (e.g., fx, fy) and principal point location (e.g., cx, cy), and an extrinsic transformation between infrared and depth or an extrinsic transformation between color and depth. A depth-relative translation and orientation may be pre-calculated and stored in the camera 104, When multiple cameras 104 are used, the intrinsic and extrinsic properties between the multiple cameras 104 may be predetermined or computable.

The camera 104 and depth sensor 106 may be separate components, and the relationship of two-dimensional images and depth information may be determined when the system 100 is manufactured, set up, or in operation.

The depth sensor 106 may use stereo visible light (e.g., multiple cameras 104), stereo infrared light, structured light, time-of-flight, or similar technique to generate a depth map or depth image. The depth sensor 106 may be integral with a camera 104, such as in the example of an RGB-D camera. The depth sensor 106 may be realized by multiple cameras 104 operating in conjunction, such as stereo visible light/IR cameras 104, and therefore the depth sensor 106 may not be a distinct component. In other systems, depth data may be derived from other data, such as captured images on a host controller, such as a depth map obtained from photogrammetry techniques. A depth image may include two-dimensional coordinates each with a depth value indicative of a distance from the depth sensor 106, A depth image may be converted to a set of three-dimensional coordinates in a world or other coordinate system.

The platform 110 may be a flat plate or similar object. The platform may have a planar top surface 112 that is generally exposed to the fields of view of the camera 104 and depth sensor 106, The platform 110 may be rectangular, circular, or have another shape. The target object 102 may be placed directly on the platform 110, may be held above the platform by a support that sits on or near the platform 110, or may otherwise be positioned near the platform 110.

The platform 110 includes physical features that may be extracted from captured images that partially or fully contain the platform 110 Such physical features may be corners of markers, centroids of circular shaped fiducials, centroids of cross-hairs, etc. Examples of additional features for the system include a specially shaped boundary of the platform 110, a specially shaped invariant line or curve on the top surface 112, a texture on the top surface 112, a marker (fiducial) provided to the top surface 112, or the like. A physical feature may have a predetermined position on the platform 110. For some applications, physical features may be extracted in captured images that are invariant with respect to rotation and scale. Invariant features may be 2D features that are unique, positioned in a small local region on the platform 110, and invariant to scale and orientation change that may result from image capture.

In this example, a plurality of markers 120 is arranged in a predetermined arrangement on the top surface 112 of the platform 110. The markers 120 may be stickers adhered to the platform 110, printed to a medium that is placed or affixed on the platform 110, etched/embossed into the platform 110, printed directly onto the platform 110, molded into the platform 110, or provided in a similar manner.

The quantity and arrangement of markers 120 are readily configurable for specific use cases. For example, a particular pattern of markers may be provided to a platform 110 for a system 100 that is to scan a particular class of target objects, such as human feet for the making of customized or orthopedic footwear. In another example, a particular pattern of markers 120 may be printed to a medium, such as paper, and placed on top of a generic platform 110.

The controller 108 may include a central processing unit (CPU), a microcontroller, a microprocessor, a processing core, a processor, a field-programmable gate array (FPGA), an application-specific integrated circuit (ASIC), or a similar device capable of executing instructions. The controller 108 may cooperate with a non-transitory machine-readable medium that may be an electronic, magnetic, optical, or other physical storage device that encodes executable instructions. The machine-readable medium may include, for example, random access memory (RAM), read-only memory (ROM), electrically-erasable programmable read-only memory (EEPROM), flash memory, a storage drive, an optical device, or similar.

The controller 108 may be connected to the camera 104 to control the camera 104 to capture images of the planar platform 110 and a target object 102, if present. The camera 104 may be aimed such that the platform 110 and object 102, if present, are fully or partially contained in such captured images. The controller 108 may be connected to the depth sensor 106 to capture depth data of the planar platform 110 and target object 102, if present.

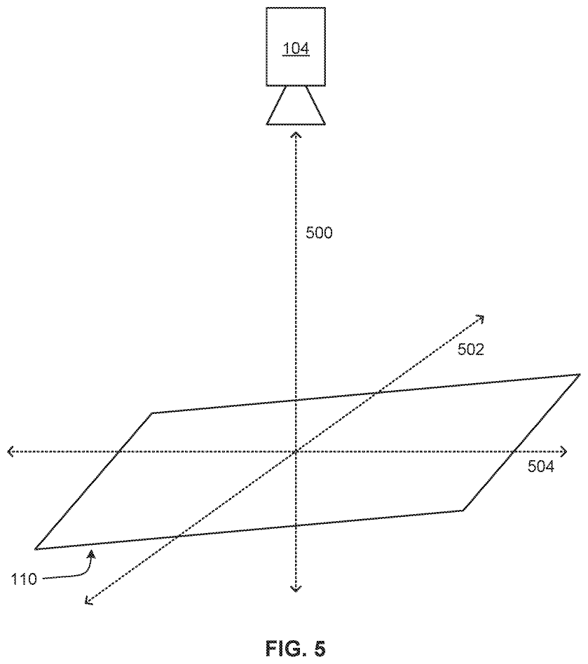

The controller 108 determines a pose of the camera 104 using the depth data and features extracted from a captured image, specifically the depth data and image features of the planar platform 110. To achieve this, the depth data may be used to define a mathematical plane that represents the planar surface 112 of the platform 110 and image features may be located within the captured image. Then, a 3D transformation may be applied to position the plane orthogonal to the camera's Z-axis (e.g., axis 500 of FIG. 5) and further transform the detected marker positions to remain in the plane. Then, the marker positions may be referenced to perform a 2D transformation to move the camera's viewpoint to align the markers with a feature reference. The camera's pose in world space can then be determined given a predetermined orientation of the platform 110 that defines the plane in world space.

In another example, the controller 108 may solve a system of equations that define the 3-dimensional marker positions in a coordinate system, such as camera coordinate system defined relative to the camera 104, with the plane function in the same coordinate system, and with camera intrinsics. The system of equations may be solved by an error function so that the 3D transformation from the rotational and translational vectors to be solved may minimize the error between transformed marker positions, and markers being located at predetermined positions in the plane.

In other examples, other techniques to blend depth data and image feature data may be used.

Prior to determining the actual camera pose, the controller 108 may process the depth data to fit it to a plane equation. Since the planar platform 110 is partially or fully represented by the depth data, the controller 108 may fit the 3-dimensional data (X, Y, Z), which are generated from individual pixels of the depth data that partially or fully represents the platform 110, to a plane equation such as AX+BY+CZ+D=0. A plane segmentation may be first used to find all 3-dimensional points that meet requirements and tolerances of a plane. A least-mean-square fit after outlier removal may be used for plane fitting. As such, error in representing the platform 110 may be reduced. Reduced error in the depth data may increase the accuracy of the determined camera pose. Processing of depth data may include processing all depth data or only processing depth data in a region of interest. In addition, depth data may be filtered, spatially and/or temporally, to smooth the depth data before fitting it to the plane equation, so as to further increase accuracy.

Further, prior to determining the actual camera pose, the controller 108 may to align the captured image and depth data to a common frame of reference. As discussed above, a relationship may exist between the relative poses of the camera 104 and the depth sensor 106, whether this relationship is established at factory or determined at time of operation. For example, the common frame of reference may be defined by the pose of depth sensor 106. Hence, the relationship may be referenced to align the coordinates of pixels in the captured image to a coordinate system defined by the depth sensor 106. In another example, the common frame of reference may be defined by the center of projection of the camera 104 and depth data may be aligned to image coordinates. In still another example, depth data is provided by stereo cameras 104 and the common frame of reference is the center of projection of one of the cameras 104.

An image used to determine camera pose may be specific to pose determination and may be subsequently discarded. Alternatively, an image captured to determine camera pose may also be used to obtain information of the target object 102. That is, the calibration may be performed after the target object 102 is placed on the platform 110 and using the same image.

A camera's pose, which may also be termed its extrinsic transformation, is described by six degrees of freedom, such as the camera's coordinates in 3D space (e.g., Tx, Ty, Tz) and the camera's orientation (e.g., Rx, Ry, Rz) relative to an origin or datum in a world coordinate system. A camera's pose may be determined and used in a calibration by computing and validating aligned 3D data of the target object 102. The calibration may be referred to as a field calibration, that is, a calibration that is performed after the system 100 is assembled and during operation of the system 100.

A nominal camera pose may be a pose expected when the system 100 is in use. Nominal camera poses may be chosen based on specific use cases, such as the type of target object to be scanned, lighting constrained, potential obstructions in a camera's field of view, and the like. An actual pose may differ from a nominal pose due to various reasons, such as inaccurate setup of the system 100, movement of the camera 104 and/or platform 110 over time, vibrations in the building that houses the system 100, and so on.

A pose of the camera 104 may be stored by the controller 108 for use in a calibration. The calibration may be applied to data extracted from images of a target object 102 to obtain accurate 3D data for the target object 102, so that the target object 102 may be modelled accurately. In other examples, such as in VR/AR scene reconstruction, the calibration may be used when reconstructing a scene on or over the planar platform 110.

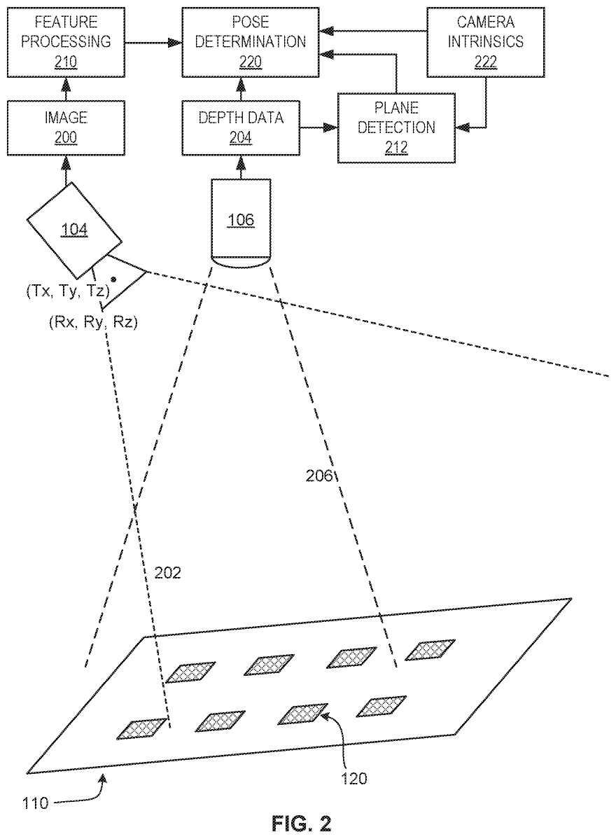

FIG. 2 shows an example determination of camera pose using image features and depth data.

A camera 104 captures an image 200 in its field of view 202. A depth sensor 106 captures depth data 204 in its field of view 206. The fields of view 202, 206 may be the same, similar, or different and have a relationship that may be predetermined or determined at time of operation. A planar platform 110 is partially or fully present in the overlapping fields of view 202, 206 and therefore represented in the captured image 200 and depth data 204.

The captured image 200 may undergo feature processing 210 to identify features of the platform 110, such as markers 120, which may be laid out on the platform 110 according to a predetermined arrangement. The predetermined arrangement may have a predetermined pose in world space (a world coordinate system). Additionally or alternatively, a given marker 120 may have a predetermined location in world space. As such, the position of the markers 120 may be referenced to determine camera pose in world space.

A marker 120 may include areas of contrast that are decodable into a set of coordinates identifying the position of the marker 120 on the platform 110 or a numeric or alphanumeric code (e.g., 1001) that signifies such position. A marker 120 may be in the shape of a square, rectangle, circle, donut, line pattern, crosshair, or similar pattern of contrasting areas. Examples of suitable markers 120 include ArUco markers, 2D barcodes (e.g., Quick Response or QR codes), circular markers, conic sections; surface texture, or similar. The position of a marker 120 on the platform 110 may be defined as the position of a corner, center, or a similar point of the marker. The platform 110 may be situated at a selected position and orientation in six degrees of freedom to provide a world coordinate space origin (e.g., a selected corner of the platform).

A marker 120 may encode its position on the platform 110 or its position within a predetermined arrangement of markers 120. Hence, feature processing 210 may include detecting the apparent position of a marker in the image 200 and decoding the marker 120 to obtain its actual position with reference to the platform, the arrangement of markers, or other datum. The position of a marker 120 in the image 200 may be expressed in pixels.

The depth data 204 is processed to detect the plane defined by the platform 110. Plane detection 212 may include time-averaging depth data 204 to smooth error, obtaining a point cloud from the depth data 204 (e.g., X, Y, Z coordinates for each pixel in a depth image), and plane segmentation to detect the plane of the platform 110 to the extent present in the field of view 206. Plane coefficients are obtained. That is, the coefficients A, B, C, D of the plane equation:

AX+BY+CZ+D=0 (Equation 1)

are obtained. A fitting function may be applied to reduce or minimize error in the plane coefficients.

Pose determination 220 uses feature locations as determined from the captured image 200 and depth data 204 as represented by the detected plane to compute the camera pose (Tx, Ty, Tz, Rx, Ry, Rz). Intrinsic properties 222 of the camera 104 are also referenced. From each measured marker position x, y in the image, a homogeneous coordinate may be computed from Equations 2:

xh=(x−cx)/fx

yh=(y−cy)/fy

where fx and fy are camera focal length and cx and cy are the camera's principal point.

Homogeneous 3D coordinates according to a pin-hole camera model (xh, yh, zh) can be expressed as Equations 3:

xh=X/Z

yh=Y/Z

zh=1

where X, Y, Z describe each point of the plane as viewed from the camera 104.

Further, 3D points are generated for each detected marker position as viewed from the camera 104, as the homogeneous coordinate obtained from each 2D point forms a ray from the camera 104 to the target and that ray intersects the plane.

Hence, the plane, as computed from the depth data, and the positions of the markers, as determined from the image, may be expressed as mathematically in a common coordinate system, such as a coordinate system define for the camera or a world coordinate system.

Camera pose may thus be computed based on three rotations around the world X, Y, Z axis respectively, Rx, Ry, Rz (also known as pan, yaw, roll), and three translations which are the relative distance (Tx, Ty, Tz from the camera origin to the world origin.

Geometric transforms may be used. For example, first a transformation between the camera and the plane may be computed. A normal transformation, T1, may be used to align the plane normal to an aiming direction of the camera. Such transformation, T1, may solve the camera to plane orientation around the camera's X and Y axes, as well as the translation from the camera to the plane in the camera's Z direction. With reference to FIG. 5, the transformation, T1, makes plane normal to the camera axis 500 and determines the distance from the camera to the plane along the axis 500.

Then, using the above transformation T1, the detected points solved in Equations 1, 2, and 3 may be projected into the camera's Z=0 plane. That is, the marker locations are also transformed so that the marker locations remain in the plane, as constrained by the markers 120 being positioned on the platform 110.

Subsequently, an affine transformation of inlier marker points, T2, may be computed. This may be considered a 2D alignment between the transformed, plane-projected 2D points Xp, Yp (Zp=0) and the reference coordinates of the corresponding points Xw, Yw (Zw=0). A feature reference or template of markers may be used. This transformation, T2, solves the camera to plane orientation around the Z axis of the camera (axis 500 in FIG. 5), as well as the translation between the camera and the plane in X and Y directions relative to the camera (directions perpendicular to axis 500 in FIG. 5).

Finally, the transformations, T1 and T2, may be combined, such that the camera's pose=T1*T2.

In other examples, Equations 1, 2, and 3 may be applied as constraints in a computation that reduces or minimizes error. A cost-function through non-linear mean square optimization, for example, a Levenberg-Marquardt algorithm may be used.

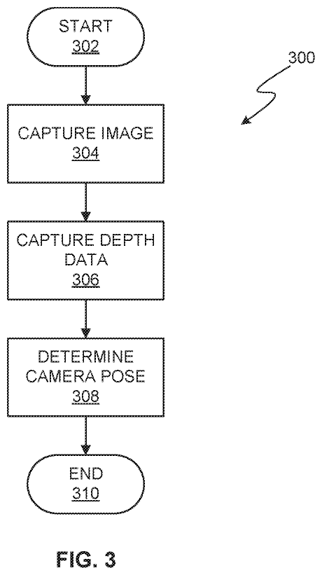

FIG. 3 shows an example method 300 of determining camera pose using feature detection and depth data. The method 300 may be performed with any of the devices and systems described herein. The method 300 may be embodied by a set of controller-executable instructions that may be stored in a non-transitory machine-readable medium. The method begins at block 302.

At block 304, a camera captures an image of a scene. The image may be a visible light image, an IR image, or a combination of such. The scene includes a planar platform including detectable features, such as markers, markers encode for position information, physical features of the platform, or similar. A target object may be situated on or above the platform.

At block 306, depth data is captured for the scene, including depth data of the planar platform. Multiple depth images may be acquired for depth averaging and noise reduction.

At block 308, a pose of a camera is computed. Expected positions of features, such as a predetermined arrangement of the markers on the platform, may be combined with information (e.g., plane-defining A, B, C, D coefficients) that defines the plane of the platform, as obtained from the depth data, and predetermined camera intrinsic parameters, to obtain the pose of the camera.

Further, a calibration may be generated with reference to the computed camera pose and homography information of detected markers (e.g., a relation between 2D image coordinates and 3D world coordinates), The calibration may map 2D image coordinates captured by the camera to 2D world coordinates. The calibration may be referenced when generating 3D data of the target object from captured 2D images, or from captured multiple target objects from a plurality of depth cameras.

The method 300 ends at block 310. The method 300 may be repeated continuously, regularly, or periodically while a system is in operation. The method 300 may be performed without a target object located on the platform. The method 300 may be performed with a target object located on the platform and redundancy in placement and/or number of unique markers may provide sufficient robustness to generate the calibration when fewer than all unique markers are detected and decoded.

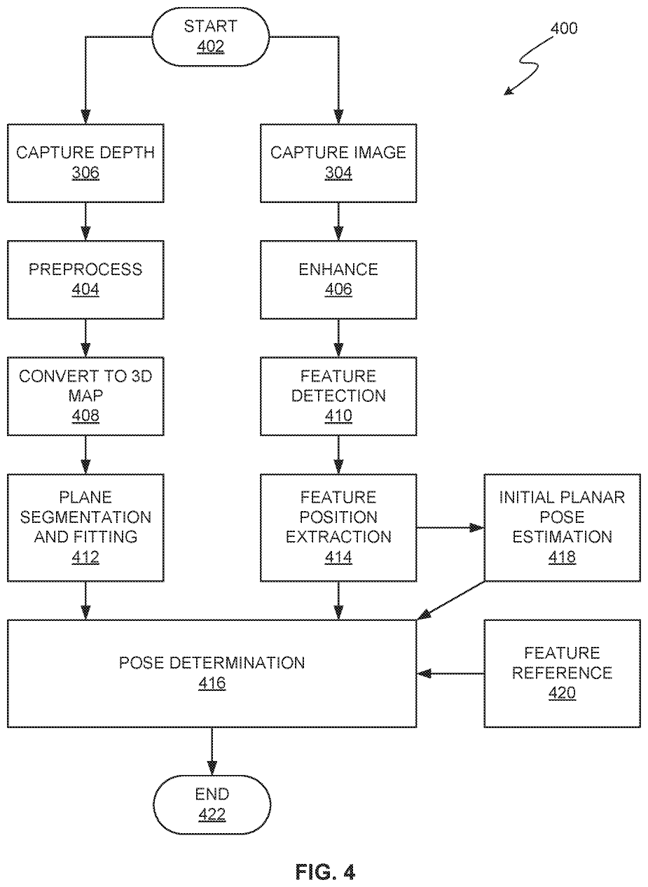

FIG. 4 shows an example method 400 of determining camera pose using feature detection and depth data. The method 400 may be performed with any of the devices and systems described herein. The method 400 may be embodied by a set of controller-executable instructions that may be stored in a non-transitory machine-readable medium. The method begins at block 402.

At blocks 304, 306, an image and depth data are captured, as discussed elsewhere herein.

At block 404, the depth data is preprocessed. Noise may be reduced or removed. This may include average depth data over time, filtering depth data (e.g., a bilateral filter), or similar operation to reduce the effects of environmental or sensor-related error, Depth data may be cleaned in the spatial domain, time domain, or both.

At block 406, the captured color or IR image is enhanced. This may include applying a filter, such as a sharpness filter, adjusting contrast or brightness, or similar operation to increase likelihood of detection of features, such as markers, in the image.

At block 408, if the depth data is in the form of a depth image, such as x, y image coordinates and a depth value in units that correspond to a world coordinate system, then the depth data is converted to a point cloud. A point cloud may be expressed as x, y, z coordinates in a world coordinate system.

At block 410, feature detection is performed on the enhanced image. Various examples of features that may be detected are described elsewhere herein.

Regarding ArUco markers, these fiducials are square-shaped and include an outer border that establishes the fiducial's boundary, and an interior region that encodes an identifier using varying, pre-determined configurations of black and white squares. A system that detects ArUco markers may take as input an image of a planar target with ArUco markers printed on it and a pattern or arrangement describing the location of the marker or the pattern of multiple markers. Feature detection may include determining the locations of the four corners of each detected ArUco marker given in camera pixel coordinates and the corresponding marker identifier. Gaussian blurring for noise suppression and bilateral filtering are examples of enhancements (block 406) that may improve ArUco marker detection. Other examples of enhancement include image pyramid (up-sampling followed by down-sampling after rough detection) and image thresholding. Such enhancements may make the marker corners easier to detect and may increase the speed of detection by shrinking the amount of data to process. For instance, once a rough outer polygon is detected, the precise corner locations may be refined with corner localization. The interior of the polygon may then be analyzed to extract the marker identifier. Identification of the marker based on the defined identifier may serve to verify that the corners detected correspond to a valid marker and, hence, the corners may be used to reference an inputted pattern layout. A list of detected points paired with corresponding identifiers may then be outputted for camera localization.

Regarding circular markers, there are various circular fiducial designs which may be processed by detecting individual markers as visible to the camera using ellipse detectors, determining the identifiers of the circles based on a pattern encoded into each circle, estimation the centers of the circles to subpixel accuracy, using the determined centers as the feature coordinates, and finding the homography between a reference plane obtained from depth data (e.g., a plane of a platform) and the image of circular markers acquired by the camera.

Regarding conic sections, these are geometry primitives, such as various conic sections (e.g., circles, ellipses, second order parametric curves, etc.). Perspective distortion of these shapes and their relatively simple mathematical representations allow for homography between a reference plane obtained from depth data (e.g., a plane of a platform) and a captured camera image containing conic sections to be readily computed.

Regarding textures, a texture may be selected to uniquely and repeatably mark local features (e.g., points of interest) for feature matching. A selected texture may be invariant to scale and rotation and should be robust against lighting and minor viewpoint variations. Feature detection of a texture may include identifying feature points using image matching techniques, such as scale invariant feature transform (SIFT), speed up robust feature (SURF), binary robust independent elementary features (BRIEF), oriented FAST, rotated BRIEF (ORB), or similar. An index of feature points may be determined and compared to indexed feature points from a reference texture image. Then, a transformation (homography) between a plane of the texture and a reference plane obtained from depth data (e.g., a plane of a platform) may be obtained.

At block 412, plane segmentation and fitting are performed on the depth data. A plane representative of the platform is obtained. A plane equation of the form:

AX+BY+CZ+D=0

may be used to determine coefficients (A, B, C, D) that define the plane. Fitting may include least-mean-square with outliers removed or similar technique.

At block 414, positions of detected features are determined. Detected markers may be decoded. For example, a predetermined decoding scheme may be referenced to convert areas of contrast (e.g., bright and dim patches) arranged in a detectable pattern into a position or code representative of a position. Feature detection and perspective correction may be used for marker detection and/or decoding.

A unique marker may be disregarded if the unique marker appears in the image with imaging quality that fails to meet a minimum quality. This may occur under low or poor-quality environmental light. Further, a unique marker may be hidden or obscured by the target object or may be subject to other condition that renders the unique marker obscured or undecodable.

At block 416, the pose of the camera may be determined with reference to the locations of the detected features and the plane obtained from the depth information, as discussed elsewhere herein. With reference to FIG. 5, the plane provides accuracy as to the distance of the platform 110 from the camera 104 along the camera axis 500 and as to the rotation of the platform 110 about orthogonal axes 502, 504 that are perpendicular to the camera axis 500. The locations of detected features provide accuracy as to the rotation of the platform 110 about the camera axis 500 and the position of the platform 110 along orthogonal axes 502, 504. The accuracies in the depth and feature domains are complementary and increase the overall accuracy of determining camera pose.

Position information determined from image features, at block 414, may be used to perform an initial planar pose estimation, at block 418, which may be provided for pose determination, at block 416.

A feature reference for the arrangement of features may be provided, at block 420, to the pose determination, at block 416. The reference may be a template or other descriptor that defines the locations of the features on the platform. The feature reference may be a ground truth of the features of the platform. This information may be used to fit detected features to the template to reduce individual error in feature location. That is, the determination of feature positions may be made for a set of detected features considered together, rather than each feature individually. In effect, a set of detected features may form a super-feature that provides for greater accuracy.

The method 400 ends at block 422. The method 400 may be repeated continuously, regularly, or periodically while a system is in operation. The method 400 may be performed without a target object located on the platform. The method 400 may be performed with a target object located on the platform and redundancy in placement and/or number of unique markers may provide sufficient robustness to generate the calibration when fewer than all unique markers are detected and decoded.

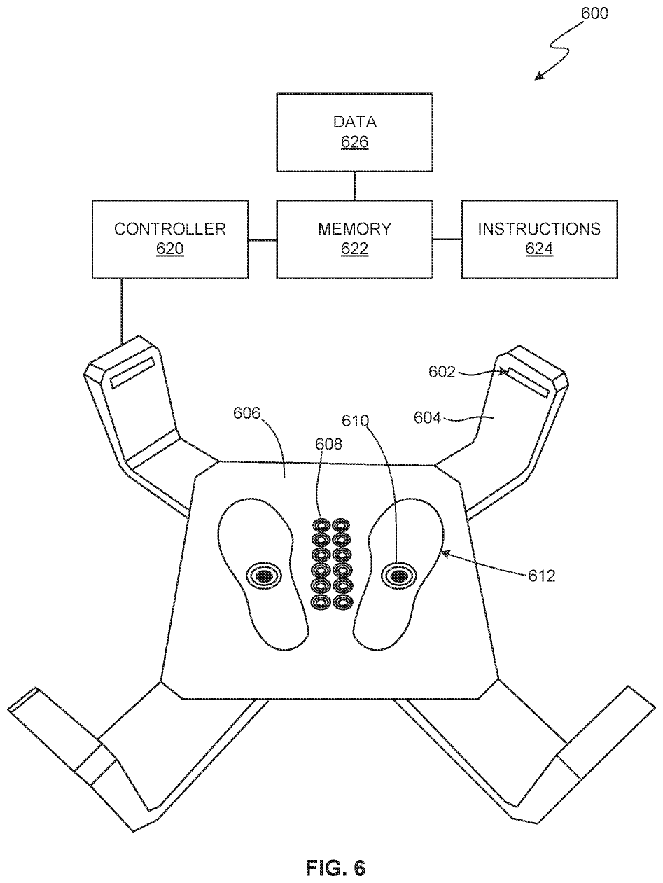

FIG. 6 shows an example system 600. The system 600 is similar to the system 100 and only differences will be described in detail. The system 100 may be referenced for further description. In this example, the system 600 is to capture images of a user's feet to generate 3D models of the feet to allow for customized orthopedic footwear to be created for the user.

The system 600 may include a plurality of cameras 602 secured together by respective arms 604. The arms 604 position the cameras 602 around and above a planar platform 606 that carries an arrangement of markers 608, 610. The cameras 602 are aimed centrally downwards toward the platform. The cameras 602 include depth sensors and may be RGB-D cameras.

The markers 608, 610 may be arranged on the platform 606 in a pattern than allows three or more non-colinear markers to be visible to each camera 602 when an object, in this example a person's feet, are situated on the platform.

The platform 606 may further include guide marks 612, such as an outline of a foot, to inform the user where to stand.

The system 600 may further include a controller 620 and memory 622, such as a machine-readable medium, connected to the controller 620. The memory 622 may store executable instructions 624 to carry out functionality described here. The memory 622 may store relevant data 626, such as camera poses, calibration data, and the like.

The controller 620 may be connected to the cameras 602 and may execute the instructions 624 to capture images and depth data of the platform 606. The instructions 624 may further determine a camera pose for each camera 602, as discussed elsewhere herein, using imaged markers 608, 610 and a plane of the platform 606 determined from the depth data.

Further, the controller 620 may verify a pose of a camera 602 and the alignment to another camera 602 that overlaps in the field of view based on the computed pose of that camera 602. The cameras 602 may be mutually fixed in space by the arms 604. The relative pose between the two cameras 602 may be computed after the two individual poses are determined. Hence.the controller 620 may align from one camera coordinate to the other camera coordinate after the controller converts marker image coordinates to camera coordinates of that camera with depth and captured images. The controller 620 then transforms the 3D locations viewed by the first camera to the second camera, and measures the offset to the 3D locations viewed by the second camera based on the common markers. If the alignment offset between the two cameras is outside of expected by a margin, then the pose computation of both cameras may be redone. That is, failure to verify a pose may trigger re-computation of the pose. Imaging parameters, such as filter settings, contrast/brightness, etc., may be varied during re-computation in case environmental conditions or other sources of error exist.

Pose verification may be constrained to markers 608, 610 captured and decoded by the relevant cameras 602. That is, a first camera 602 that captured and decoded a first set of markers 608, 610 may have its pose verified by a second camera 602 that captured and decoded a second set of markers 608, 610. The markers 608, 610 contained in both the first and second sets may be used to verify the pose of the first and/or second camera 602.

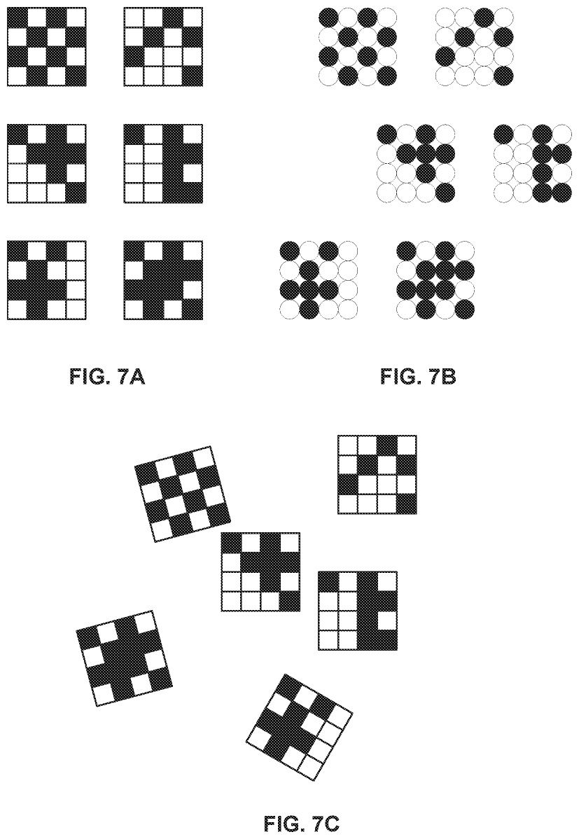

FIGS. 7A to 7C show example types and arrangements for markers. The position and orientation of markers may be selected to meet a use case. Different types and shapes of markers may be used.

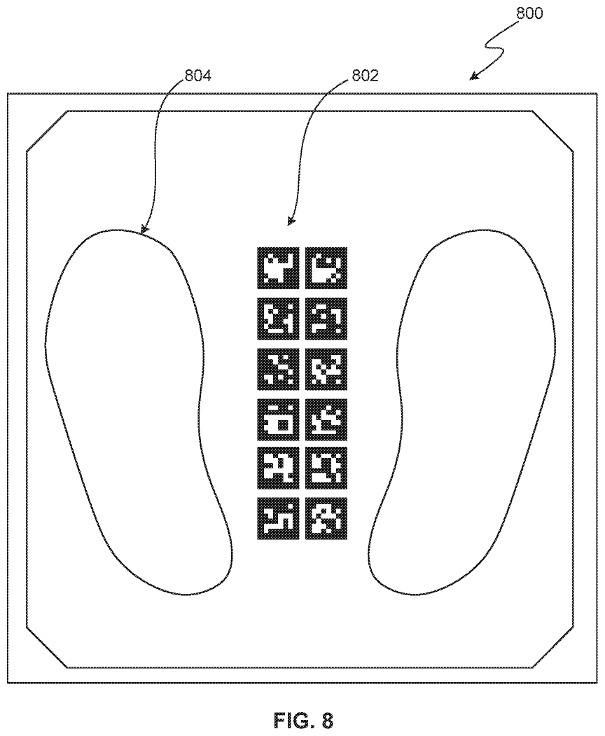

FIG. 8 shows an example platform 800 that may be used with any of the systems, devices, and methods discussed herein. The platform 800 includes an arrangement 800 of decidable markers, such as ArUco markers. The arrangement 800 may be a grid-like pattern, as shown, or another pattern. The arrangement 800 may be located between two guides 804, which indicate where a user is to stand to capture 3D data of the user's feed.

It should be apparent from the above, that an accurate and robust way of obtaining camera pose in six degrees of freedom is provided. A specialized calibration object is not required. Constraining depth data to fit a plane approaches ground truth for the planar platform as the number of depth datapoints used increases due to regression to the mean. Further, sparse markers are possible. For instance, three or four markers are sufficient in various implementations. Fewer markers may increase the speed of pose determination, as marker detection may be processing intensive relative to depth mapping.

It should be recognized that features and aspects of the various examples provided above can be combined into further examples that also fall within the scope of the present disclosure. In addition, the figures are not to scale and may have size and shape exaggerated for illustrative purposes.

1. A system comprising:
a camera aimable at a planar platform;
a depth sensor aimable at the planar platform; and
a controller to control the camera to obtain a captured image of the planar platform, the controller further to control the depth sensor to capture depth data of the planar platform, the controller further to determine a pose of the camera using the depth data and features extracted from the captured image.

2. The system of claim 1, wherein the controller is further to determine the pose of the camera by a constraint of a plane equation from the depth data.

3. The system of claim 1, wherein the controller is further to align the captured image and depth data to a common frame of reference prior to determination of the pose of the camera.

4. The system of claim 1, wherein the controller is further to extract a plane from the depth data of the planar platform, and wherein the controller is further to use a plane equation and the features extracted from the captured image to determine a three-dimensional pose of the camera.

5. The system of claim 1, wherein the controller is further to extract a feature from a representation of an invariant feature on the planar platform in the captured image.

6. The system of claim 1, wherein markers are arranged on the planar platform in a predetermined arrangement, and wherein the controller is further to extract a feature or multiple features from a representation of a marker in the captured image.

7. The system of claim 6, wherein the controller is further to compare the representation of the marker in the captured image to a feature reference of the markers to determine the pose of the camera.

8. The system of claim 6, wherein a marker encodes a position of the marker on the planar platform, and wherein the controller is further to decode the marker to obtain the position to determine the pose of the camera.

9. The system of claim 6, wherein the marker includes texture.

10. The system of claim 1, further comprising the planar platform, wherein the planar platform is to receive a target object, and wherein the controller is to control the camera to obtain captured images of the target object and to extract three-dimensional data from the captured images with reference to the pose of the camera.

11. A non-transitory machine-readable medium comprising instructions executable by a controller to;
obtain an image of a planar object captured by a camera;
detect, in the image, markers on the planar object;
obtain depth data of a planar object; and
determine a pose of the camera using the depth data and locations of the markers detected in the image.

12. The non-transitory machine-readable medium of claim 11, wherein the instructions are further to determine a plane from the depth data, wherein the plane represents the planar object, wherein the instructions are further to use the plane and the locations of the markers to determine the pose of the camera.

13. The non-transitory machine-readable medium of claim 12, wherein the instructions are further to fit a point cloud of the depth data to a plane equation to define the plane.

14. A system comprising:
a planar platform;
a plurality of cameras to capture images and depth data of the planar platform; and
a controller connected to the plurality of cameras to extract features from the images, determine a plane of the planar platform from the depth data, and determine poses of the plurality of cameras based on the features and the plane.

15. The system of claim 14, wherein the controller is further to verify an accuracy of a pose of a camera of the plurality of cameras.
